(19) United States
(12) Patent Application Publication
(10) Pub. No.: US 2018/0335627 A1
(43) Pub. Date: Nov. 22, 2018

(54) PROJECTION TYPE DISPLAY DEVICE

(71) Applicant: FUJIFILM Corporation, Tokyo (JP)

(72) Inventor: Koudai FUJITA, Saitama (JP)

(73) Assignee: FUJIFILM Corporation, Tokyo (JP)

(21) Appl. No.: 16/049,833

(22) Filed: Jul. 31, 2018

Related U.S. Application Data
(63) Continuation of application No. PCT/JP2017/000772, filed on Jan. 12, 2017.

(30) Foreign Application Priority Data
Feb. 22, 2016 (JP) 2016-030906

(51) Int. Cl. G02B 27/01; G09G 3/02; B60K 35/00; B60R 11/02

(52) U.S. Cl. CPC G02B 27/0149; G09G 3/02; B60K 35/00; B60R 2011/0005; G02B 2027/0158; B60K 2350/2052; B60K 2350/92; B60R 11/0229

(57) ABSTRACT

An HUD 100 includes a housing 7 that accommodates a light source unit 40, a light modulation element 44 that spatially modulates light emitted from the light source unit 40 on the basis of image information, and a diffusion member 5 and a concave mirror 6 that project the spatially modulated image light onto a windshield 2 through an opening portion 30 provided in a dashboard 3 of an automobile 1, and is supported to be rotatable inside the dashboard 3; an actuator 10 that drives the housing 7 to be rotatably; and a tubular flexible member 9 that connects a peripheral edge of an opening surface 30A of the opening portion 30 and a peripheral edge of a light emitting surface 8A of the image light in the housing 7.

### CROSS-REFERENCE TO RELATED APPLICATIONS

This application is a Continuation of PCT International Application No. PCT/JP2017/000772 filed on Jan. 12, 2017, which claims priority under 35 U.S.C § 119(a) to Japanese Patent Application No. 2016-030906 filed on Feb. 22, 2016. Each of the above application(s) is hereby expressly incorporated by reference, in its entirety, into the present application.

### BACKGROUND OF THE INVENTION

### 1. Field of the Invention

The present invention relates to a projection type display device.

### 2. Description of the Related Art

A vehicle head-up display (HUD) that projects, using a windshield in a vehicle such as an automobile, a train, a ship, heavy equipment, an aircraft, or agricultural machinery, or a combiner disposed in the vicinity of the windshield as a screen, light onto the screen to display an image is known. According to such an HUD, a driver can visually recognize an image based on light projected from the HUD as a real image on the screen, or as a virtual image in front of the screen.

As the HUD, there is an HUD in which a projection range of light is fixed, and is also an HUD in which a projection range of light is movable in a vertical direction, for example (for example, JP2004-130892A and JP2015-051658A).

JP2004-130892A discloses an HUD that is provided in a dashboard of an automobile. The HUD includes an installation frame fixed in an opening portion of the dashboard, a case in which a display device and a projection optical system are built, and a flexible connecting member that connects the installation frame and the case.

In this HUD, the case is supported to be rotatable in the dashboard, and a projection range of light cab be changed in accordance with the rotation of the case. According to the HUD, even in a case where the case is rotated, since there is no gap between the case and the installation frame due to the connecting member, it is possible to prevent dusts or the like from entering the inside of the case. JP2004-130892A also discloses a configuration in which the case is disposed inside the installation frame and the connecting member is provided to fill a gap between the installation frame and the case.

JP2015-051658A discloses an HUD that is provided in a dashboard of an automobile. This HUD has a configuration in which a concave mirror for reflecting light from a display device onto a windshield is provided to be rotatable and a projection range of the light is changed in accordance with the rotation of the concave mirror. Further, in the HUD, a metal member that supports the concave mirror is formed in a bellows shape, and shock applied to the HUD is absorbed by a bellows portion.

### SUMMARY OF THE INVENTION

The HUD disclosed in JP2004-130892A has a configuration in which the flexible connecting member is provided between the installation frame and the case. Thus, in a configuration in which the installation frame, the connecting member, and the case are sequentially arranged from the opening portion of the dashboard, in a case where vibration is applied from the outside, there is a high possibility that a part of light projected from the case is blocked by the installation frame due to the influence of the thickness of the installation frame. In order to prevent such vignetting, it is necessary to restrict a rotation range of the case, or it is necessary to study design of the dashboard, which leads to an increase in cost. Further, in a case where there is a restriction in a space inside the dashboard, in order to prevent the vignetting, it is necessary to decreasing a projection range of light which leads to deterioration in display performance.

Further, in a configuration in which the case is provided in the installation frame and the connecting member is provided in the gap between the installation frame and the case, similarly, since the installation frame is fixed to the opening portion of the dashboard, due to external causes such as application of vibration from the outside, there is a high possibility that a part of light projected from the case is blocked by the installation frame. Further, in such a configuration, since the case is disposed in the vicinity of the opening portion of the dashboard, external light is easily incident into the case, or the case is easily viewed by a driver, which leads to deterioration of fine view.

The HUD disclosed in JP2015-051658A is able to change a projection range. However, there is no recognition of the problem that a part of light is blocked due to the change of the projection range due to external causes.

The invention has been made in consideration of the above-mentioned circumstances, and an object of the invention is to provide a projection type display device capable of preventing light from being blocked even in a case where a projection range of the light is changed due to external causes.

According to an aspect of the invention, there is provided a projection type display device of the invention comprises: a housing that accommodates a light source, a spatial modulation unit that spatially modulates light emitted from the light source on the basis of image information, and a projection unit that projects the spatially modulated image light onto a projection surface in a vehicle through an opening portion provided in a member in which internal parts of the vehicle are built, and is supported to be rotatable inside the member; rotation driving section that drives the housing to be rotatably; and a tubular flexible member that connects a peripheral edge of an opening surface of the opening portion and a peripheral edge of a light emitting surface of the image light in the housing.

According to the present invention, it is possible to provide a projection type display device capable of preventing light from being blocked even in a case where a projection range of the light is changed due to external causes.

### BRIEF DESCRIPTION OF THE DRAWINGS

FIG. 1 is a diagram showing a schematic configuration of an HUD 100 that is an embodiment of a projection type display device of the invention.

FIG. 2 is an enlarged view of the HUD 100 shown in FIG. 1.

FIG. 3 is an appearance perspective view schematically showing an appearance of the HUD 100 shown in FIG. 1.

FIG. 4 is a diagram showing a state where a housing 7 of the HUD 100 shown in FIG. 1 is rotated in a counterclockwise direction from a state shown in FIG. 2.

FIG. 5 is a diagram showing a state where the housing 7 of the HUD 100 shown in FIG. 1 is rotated in a clockwise direction from the state shown in FIG. 2.

FIG. 6 is a schematic diagram showing an internal configuration example of a control unit 4 of the HUD 100 shown in FIG. 1.

FIG. 7 is a diagram showing a modification example of the HUD 100 shown in FIG. 1.

### DESCRIPTION OF THE PREFERRED EMBODIMENTS

Hereinafter, embodiments of the invention will be described with reference to the accompanying drawings.

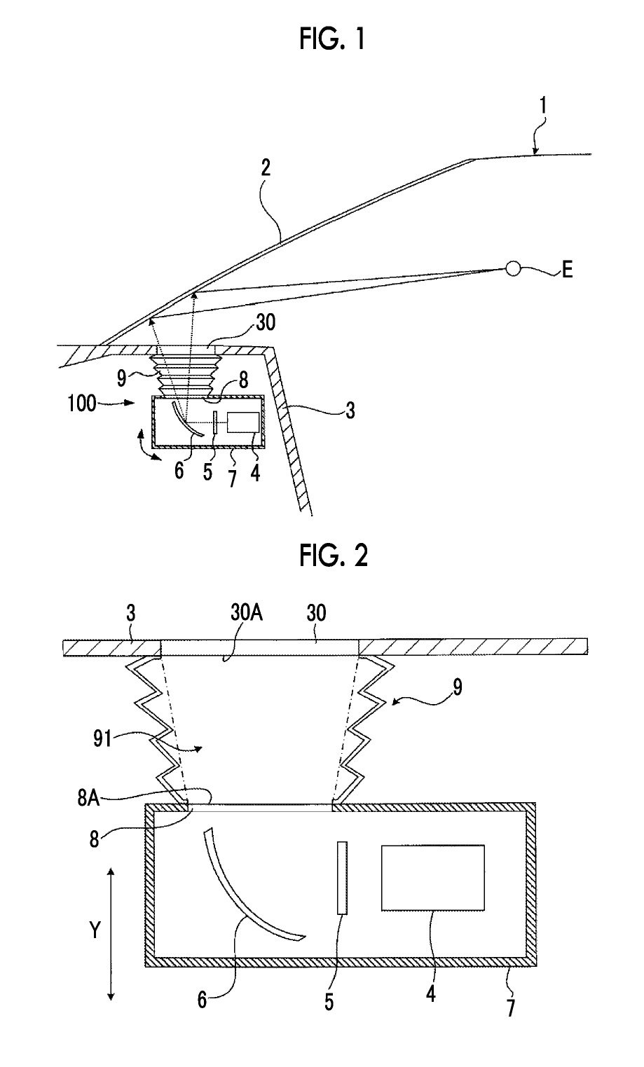

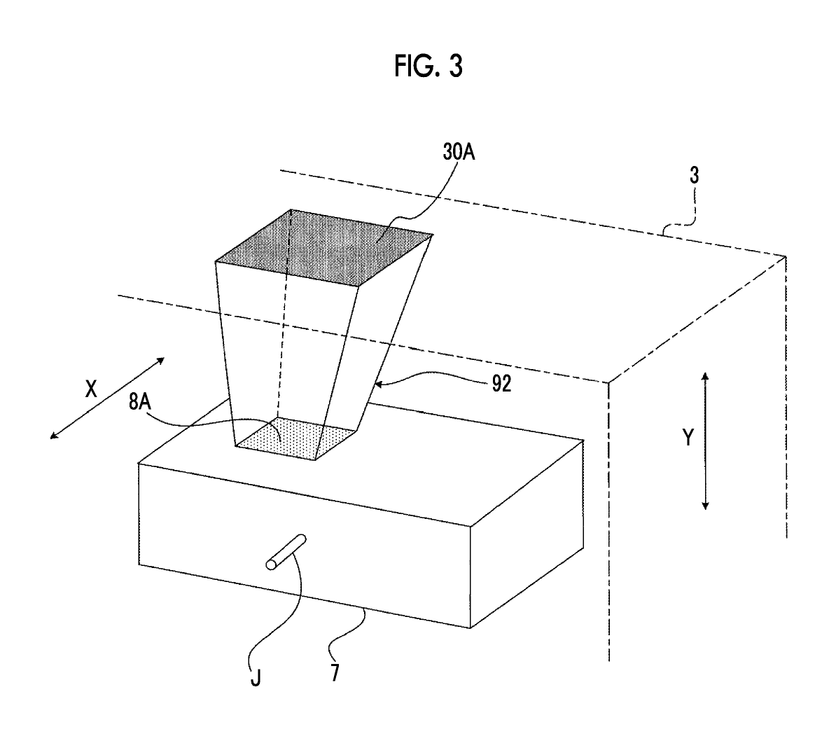

FIG. 1 is a diagram showing a schematic configuration of an HUD 100 that is an embodiment of a projection type display device of the invention. FIG. 2 is an enlarged view of the HUD 100 shown in FIG. 1. FIG. 3 is an appearance perspective view schematically showing an appearance of the HUD 100 shown in FIG. 1.

The HUD 100 is mounted in an automobile 1. A partial range of a windshield 2 of the automobile 1 is set as a projection surface, so that a virtual image or an actual image formed by or formed from the image light projected onto the projection surface is visually recognizable by a driver of the automobile 1. The HUD 100 shown in FIG. 1 may be mounted and used in a vehicle such as a train, heavy equipment, construction machinery, an aircraft, a ship, or agricultural machinery, as well as an automobile.

The HUD 100 is provided in a dashboard 3. The dashboard 3 is a member in which internal parts including various meters for notifying information for traveling, such as a speed meter, a tachometer, a fuel meter, a water temperature meter, or a range meter of the automobile 1 are provided.

An opening portion 30 is formed in the dashboard 3. In an example of FIG. 1, the opening portion 30 is configured of a hole portion formed in the dashboard 3 and a transparent member such as resin or glass inserted in the hole portion. The transparent member may not be essential, and the opening portion 30 may be the hole portion that is formed in the dashboard 3.

The HUD 100 includes a housing 7 supported to be rotatable in the dashboard 3, and a tubular flexible member 9 provided between the housing 7 and the opening portion 30 of the dashboard 3.

The housing 7 may be a box-shaped member that accommodates a control unit 4 including a light source and a spatial modulation unit that spatially modulates light emitted from the light source on the basis of image information. Further, the housing 7 accommodates a diffusion member 5 and a concave mirror 6 that form a projection unit that projects image light, which is spatially modulated by the spatial modulation unit, onto the windshield 2.

The diffusion member 5 is a member that diffuses the image light that is spatially modulated by the spatial modulation unit of the control unit 4 to become plane light. As the diffusion member 5, a micro-mirror array having a fine structure on its surface, a diffusion mirror, a reflecting holography diffuser, or the like may be used.

The concave mirror 6 enlarges and reflects image light diffused by the diffusion member 5.

On an upper surface of the housing 7, a light emitting window 8 for emitting image light reflected by the concave mirror 6 from the housing 7 is formed.

In the example of FIGS. 1 and 2, the light emitting window 8 is configured of the hole portion formed in the housing 7 and the transparent member such as resin or glass inserted in the hole portion, for example. The transparent member is not essential, and the light emitting window 8 may be the hole portion formed in the housing 7.

Among two end surfaces in an emission direction of image light in the light emitting window 8 (opening surfaces of the light emitting window 8), an external end surface 8A (see FIGS. 2 and 3) of the housing 7 forms a light emitting surface of the image light. The end surface 8A is formed in a rectangular shape as shown in FIG. 3, and may be any other shape such as a circle. The image light emitted from the end surface 8A passes through a hollow portion 91 of the flexible member 9, reaches the opening portion 30 of the dashboard 3, is emitted from the opening portion 30, and is projected onto the windshield 2.

On the windshield 2, the projected image light is processed to be reflected in a direction of the eyes E of a driver. Thus, the image light is reflected from the windshield 2, and is incident onto the eyes E of the driver. Thus, the driver can visually recognize a virtual image or an actual image based on the image light.

The HUD 100 is configured to project image light with respect to the windshield 2 in the vehicle, but may be configured to project image light onto a combiner disposed in the vicinity of the windshield 2. In this case, the combiner forms a projection surface.

The housing 7 is supported to be rotatable in the dashboard 3 in order to change a projection position of image light emitted from the end surface 8A with respect to the windshield 2.

Specifically, a rotation shaft J that extends in a direction X parallel to the end surface 8A is provided on a side surface of the housing 7, as shown in FIG. 3. The rotation shaft J is supported by an actuator such as a motor (not shown) fixed in the dashboard 3, and is driven to be rotatable.

As the rotation shaft J is driven to rotate, the housing 7 is rotated around the rotation shaft J. Thus, the projection position of image light in the windshield 2 in a gravity direction can be changed. That is, the housing 7 is supported to be rotatable inside the dashboard 3 to be able to change the projection position of the image light in the gravity direction.

As shown in FIGS. 2 and 3, the flexible member 9 is a tubular flexible member that connects a peripheral edge of the end surface 8A and a peripheral edge of the opening surface 30A, on the side of the housing 7, in the opening surface of the opening portion 30.

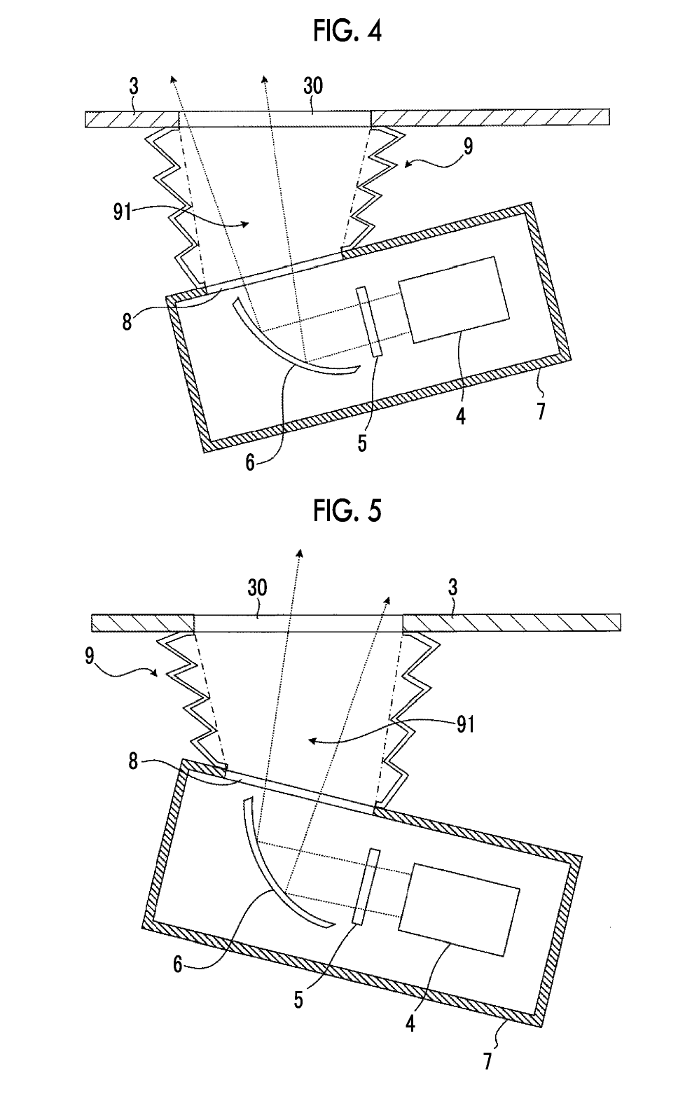

In a case where load is applied from the side of the housing 7, the flexible member 9 contracts due to the load. Further, in a case where the load is pulled toward the housing 7, the flexible member 9 extends in accordance with the tension. For example, in a case where the housing 7 is rotated at a maximum angle around the rotation shaft J in a counterclockwise direction from the state shown in FIG. 2, a state shown in FIG. 4 is obtained. Further, in a case where the housing 7 is rotated at a maximum angle around the rotation shaft J in a clockwise direction from the state shown in FIG. 2, a state shown in FIG. 5 is obtained.

The flexible member 9 is formed of a structure or a material of a rubber membrane, a bellows shape, or sponge. FIGS. 1 and 2 show an example in which the flexible member 9 of a bellows structure is used.

The housing 7 has a predetermined rotatable angle range around the rotation shaft J. Further, the hollow portion 91 of the flexible member 9 is designed in such a shape that image light emitted from the end surface 8A is capable of being emitted from the opening portion 30 without being blocked in any state where the housing 7 is rotated in the angle range.

Further, in the HUD 100, in a plan view when seen in a direction Y perpendicular to the opening surface 30A shown in FIGS. 2 and 3, the area of the end surface 8A and the area of the opening surface 30A are different from each other. Specifically, the area of the opening surface 30A is set to be larger than the area of the end surface 8A. In addition, in the plan view, the entirety of the end surface 8A is covered with the opening surface 30A.

As a result, the shape of a three-dimensional object 92 formed by a surface formed by a straight line that connects a certain point on the peripheral edge of the end surface 8A and a certain point on the peripheral edge of the opening surface 30A at the shortest distance, and the opening surface 30A and the end surface 8A becomes a tapered shape that becomes larger from the side of the housing 7 toward the side of the opening portion 30, as shown in FIG. 3. A single-dot chain line in the hollow portion 91 shown in FIGS. 2, 4, and 5 represents a line of a side surface of the three-dimensional object 92. The flexible member 9 has at least the same space as that of the three-dimensional object 92 as a hollow portion.

The reason why the three-dimensional object 92 is formed in the tapered shape is because the area of the end surface 8A and the area of the opening surface 30A are different from each other. Thus, in the plan view in the direction Y, even though the entirety of the end surface 8A is not covered with the opening surface 30A, it is possible to form the shape of the three-dimensional object 92 in a tapered shape.

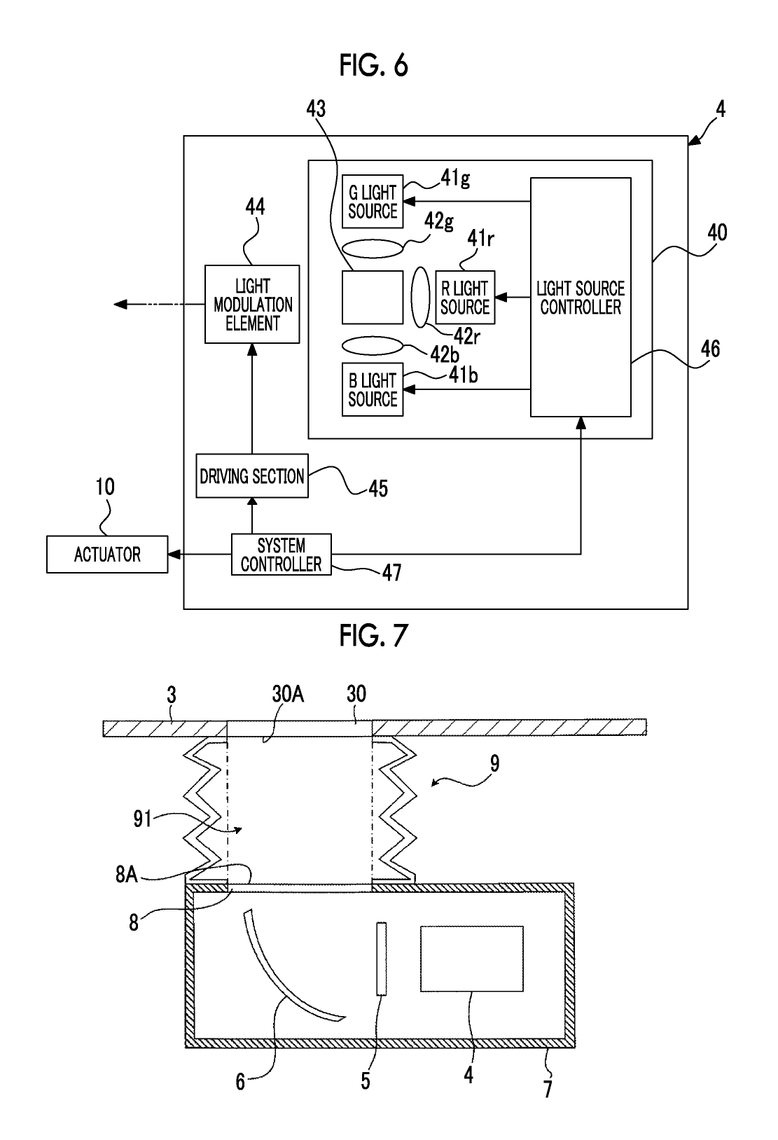

FIG. 6 is a schematic view showing an internal configuration example of the control unit 4 of the HUD 100 shown in FIG. 1.

As shown in FIG. 6, the control unit 4 of the HUD 100 includes a light source unit 40, a light modulation element 44, a driving section 45 that drives the light modulation element 44, a system controller 47 that generally controls the entirety of the HUD 100, and an actuator 10 that drives the rotation shaft J. The actuator 10 forms a rotation driving section.

The light source unit 40 includes a light source controller 46, an R light source 41r that is a red light source that emits red light, a G light source 41g that is a green light source that emits green light, a B light source 41b that is a blue light source that emits blue light, a dichroic prism 43, a collimator lens 42r that is provided between the R light source 41r and the dichroic prism 43, a collimator lens 42g that is provided between the G light source 41g and the dichroic prism 43, and a collimator lens 42b that is provided between the B light source 41b and the dichroic prism 43. The R light source 41r, the G light source 41g, and the B light source 41b form the light source of the HUD 100.

The dichroic prism 43 is an optical member for guiding light emitted from each of the R light source 41r, the G light source 41g, and the B light source 41b to the same optical path. The dichroic prism 43 transmits red light that is collimated by the collimator lens 42r to be output to the light modulation element 44. Further, the dichroic prism 43 reflects green light that is collimated by the collimator lens 42g to be output to the light modulation element 44. Further, the dichroic prism 43 reflects blue light that is collimated by the collimator lens 42b to be output to the light modulation element 44. An optical member having such a function for guiding light to the same optical path is not limited to a dichroic prism. For example, a cross dichroic mirror may be used.

The R light source 41r, the G light source 41g, and the B light source 41b may respectively employ a light emitting element such as laser or a light emitting diode (LED). In this embodiment, an example in which the HUD includes three light sources of the R light source 41r, the G light source 41g, and the B light source 41b is shown, but the number of light sources may be 1, 2, 4 or more.

The light source controller 46 sets the intensity of light emitted from each of the R light source 41r, the G light source 41g, and the B light source 41b into a predetermined light emission intensity pattern, and performs a control for sequentially emitting light from the R light source 41r, the G light source 41g, and the B light source 41b in accordance with the light emission intensity patterns.

The light modulation element 44 forms a spatial modulation unit that spatially modulates light that is emitted from the R light source 41r, the G light source 41g, and the B light source 41b and then is emitted from the dichroic prism 43 on the basis of image information input from the system controller 47.

The light modulation element 44 may employ, for example, a liquid crystal on silicon (LCOS), a digital micromirror device (DMD), a micro electro mechanical systems (MEMS) element, a liquid crystal display device, or the like.

The driving section 45 drives the light modulation element 44 in accordance with the image information input from the system controller 47, and causes light (red color image light, blue color image light, and green color image light) based on the image information to be output to the diffusion member 5 from the light modulation element 44.

The system controller 47 controls the light source controller 46 and the driving section 45 to cause image light that is spatially modulated on the basis of the image information to be output to the diffusion member 5. Further, the system controller 47 controls the actuator 10 to rotate the housing 7 around the rotation shaft J.

In the HUD 100 having the above-described configuration, in a case where the housing 7 is rotated under the control of the system controller 47, the flexible member 9 extends or contracts in accordance with the rotation, and thus, an optical path of image light is secured. Thus, the image light is emitted from the opening portion 30 without being blocked and is reflected by the windshield 2, so that a driver can visually recognize a virtual image or an actual image based on the image light.

As described above, according to the HUD 100, the peripheral edge of the opening surface 30A of the opening portion 30 and the peripheral edge of the end surface 8A of the housing 7 are configured to be directly connected to each other by the flexible member 9. With such a configuration, it is possible to deform the shape of a space through which image light passes in accordance with the rotation of the housing 7. Accordingly, it is possible to easily prevent the image light from being blocked by a component that forms the HUD 100, and to reduce the cost necessary for handling vignetting of the image light. Further, it is not necessary to restrict a rotation range of the housing 7 in order to avoid the vignetting of the image light. In addition, the design of the optical system does not become complicated.

The HUD disclosed in JP2004-130892A has a configuration in which a frame fixed in a dashboard is necessarily provided on a path through which image light passes. Accordingly, it is not possible to deform the entirety of the path through which the image light passes in accordance with rotation of a housing. On the other hand, in the HUD 100, it is possible to deform the entirety of a path through which image light passes in accordance with rotation of a housing, and thus, it is possible to easily prevent vignetting of image light.

Further, even in a case where there is a restriction in a space inside the dashboard 3, it is not necessary to take measures for narrowing a projection range of image light, for example, and thus, it is possible to enhance display performance. In addition, since the flexible member 9 is disposed between the dashboard 3 and the housing 7, the housing 7 is not easily observed from the opening portion 30, and thus, it is possible to enhance design performance of the automobile 1.

The HUD 100 has a configuration in which the flexible member 9 has a tapered hollow portion. According to this configuration, it is possible to enlarge a rotation angle range of the housing 7, and thus, it is possible to enhance display performance. Further, in a case where light is incident into the opening portion 30 from the outside of the dashboard 3, it is possible to reduce a possibility that the light goes straight using the tapered shape. Thus, it is possible to prevent deterioration in display quality due to the outside light.

Further, the HUD 100 has a configuration in which the entirety of the end surface 8A is covered by the opening surface 30A in the plan view when seen in the direction Y. According to this configuration, it is possible to enlarge a rotation angle range of the housing 7, and thus, it is possible to enhance display performance.

On an inner surface (a surface being in contact with the hollow portion) of the flexible member 9 of the HUD 100, preferably, an anti-reflection portion for preventing reflection of light is formed. As the anti-reflection portion, a member that absorbs light, such as a member that is coated with black ink, a member that has irregularities and prevents reflection of light due to the irregularities, or the like may be used. According to this configuration, it is possible to prevent reflection of outside light on the inner surface of the flexible member 9. Accordingly, it is possible to enhance display performance.

Further, the flexible member 9 of the HUD 100 preferably uses a member having flexibility with respect to load applied from the side of the opening portion 30 smaller than flexibility with respect to load applied from the side of the housing 7. The flexibility represents a characteristic indicating, in a case where load is applied to a member, how much the member extends and contracts in a direction where the load is applied. In a case where the load is applied to the member, as the amount of extension and the amount of contraction of the member become larger in the direction where the load is applied, the flexibility of the member becomes larger.

The dashboard 3 of the automobile 1 is easily affected by the influence of load, for example, in a case where a part of an object or the body is disposed due to an occupant of the automobile 1. As described above, by setting the flexibility with respect to the load applied from the side of the opening portion 30 to be smaller, it is possible to prevent position shift of the housing 7 due to shock from the outside, to thereby enhance display performance.

The housing 7 of the HUD 100 may be supported to be rotatable inside the dashboard 3 to be able to change a projection position of image light in a horizontal direction perpendicular to a traveling direction and a gravity direction of the automobile 1. With such a configuration, as the flexible member 9 extends or contracts in accordance with rotation of the housing 7, it is possible to prevent vignetting of the image light.

FIG. 7 is a diagram showing a modification example of the HUD 100 shown in FIG. 1, which is a diagram corresponding to FIG. 2. The HUD shown in FIG. 7 has a configuration in which the area of the end surface 8A and the area of the opening surface 30A are the same and the shape of the three-dimensional object is formed in a cylindrical shape. With such a configuration, similarly, it is possible to obtain an effect for preventing vignetting of image light.

As described above, the following configurations are disclosed in this specification.

A disclosed projection type display device includes: a housing that accommodates a light source, a spatial modulation unit that spatially modulates light emitted from the light source on the basis of image information, and a projection unit that projects the spatially modulated image light onto a projection surface in a vehicle through an opening portion provided in a member in which internal parts of the vehicle are built, and is supported to be rotatable inside the member; a rotation driving section that drives the housing to be rotatably; and a tubular flexible member that connects a peripheral edge of an opening surface of the opening portion and a peripheral edge of a light emitting surface of the image light in the housing.

In the disclosed projection type display device, an area of the opening surface of the opening portion and an area of the light emitting surface are different from each other in a plan view in a direction perpendicular to the opening surface of the opening portion.

In the disclosed projection type display device, the area of the opening surface of the opening portion is larger than the area of the light emitting surface.

In the disclosed projection type display device, the opening surface of the opening portion covers the entirety of the light emitting surface in the plan view.

In the disclosed projection type display device, the flexible member has a space that is formed by a surface formed by a straight line that connects a certain point on the peripheral edge of the opening surface of the opening portion and a certain point on the peripheral edge of the light emitting surface at the shortest distance, the opening surface of the opening portion, and the light emitting surface, as a hollow portion, and the hollow portion has a tapered shape that expands from the side of the housing toward the side of the opening portion.

In the disclosed projection type display device, the flexible member has flexibility with respect to load applied from the side of the opening portion smaller than flexibility with respect to load applied from the side of the housing.

In the disclosed projection type display device, an anti-reflection portion for preventing reflection of light is formed on an inner surface of the flexible member.

The invention is usable in enhancing the product value of an automobile by being mounted in the automobile.

### EXPLANATION OF REFERENCES

E: driver's eyes
100: HUD
1: automobile
2: windshield
3: dashboard
4: control unit
5: diffusion member
6: concave mirror
7: housing
8: light emitting window
8A: end surface
9: flexible member
91: hollow portion
92: three-dimensional object
10: actuator
30: opening portion
30A: opening surface
J: rotation shaft
40: light source unit
41r: R light source
41g: G light source
41b: B light source
42r, 42g, 42b: collimator lens
43: dichroic prism
44: light modulation element
45: driving section
46: light source controller
47: system controller

What is claimed is:

1. A projection type display device comprising:
a housing that accommodates a light source, a spatial modulation unit that spatially modulates light emitted from the light source on the basis of image information, and a projection unit that projects the spatially modulated image light onto a projection surface in a vehicle through an opening portion provided in a member in which internal parts of the vehicle are built, and is supported to be rotatable inside the member;
a rotation driving section that drives the housing to be rotatably; and
a tubular flexible member that connects a peripheral edge of an opening surface of the opening portion and a peripheral edge of a light emitting surface of the image light in the housing.

2. The projection type display device according to claim 1,
wherein an area of the opening surface of the opening portion and an area of the light emitting surface are different from each other in a plan view in a direction perpendicular to the opening surface of the opening portion.

3. The projection type display device according to claim 2,
wherein the area of the opening surface of the opening portion is larger than the area of the light emitting surface.

4. The projection type display device according to claim 3,
wherein the opening surface of the opening portion covers the entirety of the light emitting surface in the plan view.

5. The projection type display device according to claim 1,
wherein the flexible member has a space that is formed by a surface formed by a straight line that connects a certain point on the peripheral edge of the opening surface of the opening portion and a certain point on the peripheral edge of the light emitting surface at the shortest distance, the opening surface of the opening portion, and the light emitting surface, as a hollow portion, and
the hollow portion has a tapered shape that expands from the housing toward the opening portion.

6. The projection type display device according to claim 2,
wherein the flexible member has a space that is formed by a surface formed by a straight line that connects a certain point on the peripheral edge of the opening surface of the opening portion and a certain point on the peripheral edge of the light emitting surface at the shortest distance, the opening surface of the opening portion, and the light emitting surface, as a hollow portion, and
the hollow portion has a tapered shape that expands from the housing toward the opening portion.

7. The projection type display device according to claim 3,
wherein the flexible member has a space that is formed by a surface formed by a straight line that connects a certain point on the peripheral edge of the opening surface of the opening portion and a certain point on the peripheral edge of the light emitting surface at the shortest distance, the opening surface of the opening portion, and the light emitting surface, as a hollow portion, and
the hollow portion has a tapered shape that expands from the housing toward the opening portion.

8. The projection type display device according to claim 4,
wherein the flexible member has a space that is formed by a surface formed by a straight line that connects a certain point on the peripheral edge of the opening surface of the opening portion and a certain point on the peripheral edge of the light emitting surface at the shortest distance, the opening surface of the opening portion, and the light emitting surface, as a hollow portion, and
the hollow portion has a tapered shape that expands from the housing toward the opening portion.

9. The projection type display device according to claim 1,
wherein the flexible member has flexibility with respect to load applied from the opening portion smaller than flexibility with respect to load applied from the housing.

10. The projection type display device according to claim 2,
wherein the flexible member has flexibility with respect to load applied from the opening portion smaller than flexibility with respect to load applied from the housing.

11. The projection type display device according to claim 3,
wherein the flexible member has flexibility with respect to load applied from the opening portion smaller than flexibility with respect to load applied from the housing.

12. The projection type display device according to claim 4,
wherein the flexible member has flexibility with respect to load applied from the opening portion smaller than flexibility with respect to load applied from the housing.

13. The projection type display device according to claim 5,
wherein the flexible member has flexibility with respect to load applied from the opening portion smaller than flexibility with respect to load applied from the housing.

14. The projection type display device according to claim 6,
wherein the flexible member has flexibility with respect to load applied from the opening portion smaller than flexibility with respect to load applied from the housing.

15. The projection type display device according to claim 7,
wherein the flexible member has flexibility with respect to load applied from the opening portion smaller than flexibility with respect to load applied from the housing.

16. The projection type display device according to claim 8,
wherein the flexible member has flexibility with respect to load applied from the opening portion smaller than flexibility with respect to load applied from the housing.

17. The projection type display device according to claim 1,
wherein an anti-reflection portion for preventing reflection of light is formed on an inner surface of the flexible member.

18. The projection type display device according to claim 2,
wherein an anti-reflection portion for preventing reflection of light is formed on an inner surface of the flexible member.

19. The projection type display device according to claim 3,
wherein an anti-reflection portion for preventing reflection of light is formed on an inner surface of the flexible member.

20. The projection type display device according to claim 4,
wherein an anti-reflection portion for preventing reflection of light is formed on an inner surface of the flexible member.
